(19) United States
(12) Patent Application Publication
(10) Pub. No.: US 2007/0286634 A1
(43) Pub. Date: Dec. 13, 2007

(54) Developer Roll Shield to Reduce Toner Dusting

(76) Inventors: David Clay Blaine, Dry Ridge, KY (US); Brian Lester Boettcher, Versailles, KY (US); John Paul Bradley, Lexington, KY (US); James Anthony Carter, Lexington, KY (US); Matthew Lee Rogers, Lexington, KY (US); Christopher David Strack, Lexington, KY (US); Devon Jean Vaccaro Strain, Shelbyville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/422,976

(22) Filed: Jun. 8, 2006

(51) Int. Cl. G03G 21/00

(52) U.S. Cl. 399/98

(57) ABSTRACT

A shield may be provided over a printer developer roll, adjacent to a doctor blade, to reduce toner dusting and toner accumulations. The shield may slightly conform to the curvature of the developer roll in some embodiments. As a result, toner accumulations on surface which the customer must touch may be reduced.

### BACKGROUND

This relates generally to reducing dusting of components proximate to a developer roll.

In some cases, printer components may be covered with a layer of toner dust. This toner dust originates from a variety of sources. Users noticing the accumulation of toner dust may believe that the equipment is not operating correctly.

Toner particles on the developer roll surface are sensitive to airflow magnitude and direction. If the airflow pushing force on toner particles exceeds the toner particles' electrostatic bending force to the developer roll, then the toner particles become airborne from the developer roll's surface. This phenomenon may be referred to as toner dusting, toner spray, or toner accumulation.

Historically, toner formulations and their corresponding electrostatic parameters were optimized for resistance to airflow dispersal. If the operating space allow for additional optimization, then print quality and general electrophotographic performance may then be addressed.

In many cases, the customer must remove and replace various components within the printer. In addition, the customer may be called on to clear paper jams or to perform printer maintenance. In the course of doing these activities, toner accumulation results in considerable messiness. Customers become frustrated with stray toner accumulations, because toner transfers to their clothes, documents, and the office environment.

In addition, print quality defects may be correlated to toner dusting or accumulation. Print quality defects such as background, light print, and large toner leaks may be caused by toner dusting. In addition, paper jams may be increased due to paper treeing, folded paper corners, and dirty paper corners.

Thus, it would by desirable to reduce the toner accumulation or dusting within printers.

### BRIEF DESCRIPTION OF THE DRAWINGS

FIG. 1 is a perspective view of a toner shield and developer roll in accordance with one embodiment of the present invention;

FIG. 2 is a cross-sectional view taken generally along the line 2-2 in FIG. 1 in accordance with one embodiment of the present invention;

FIG. 3 is an end view taken from the left end of the embodiment shown in FIG. 1 in accordance with one embodiment of the present invention;

FIG. 4 is a partial, exploded, perspective view of the left side of one embodiment of the present invention;

FIG. 5 is a partial, perspective view from the left side of the embodiment shown in FIG. 1 in accordance with one embodiment of the present;

FIG. 6 is a partial, exploded, perspective view of the right side of one embodiment of the present invention;

FIG. 7 is a partial, perspective view from the right side of the embodiment shown in FIG. 1 in accordance with one embodiment of the present invention; and

FIG. 8 is a depiction of a printer in accordance with one embodiment of the present invention.

### DETAILED DESCRIPTION

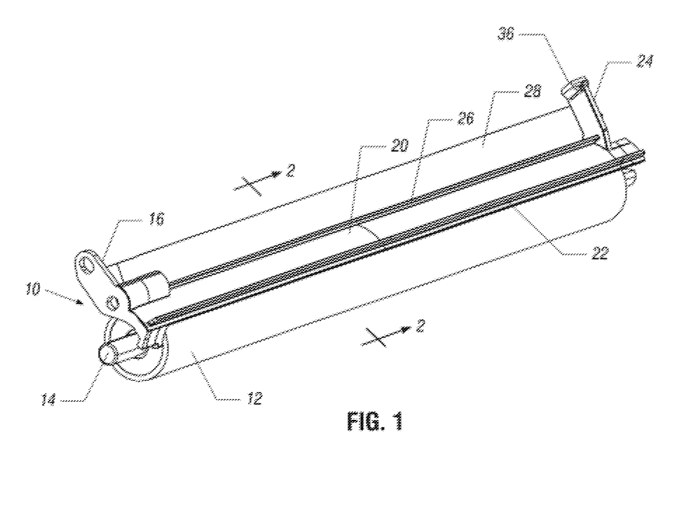

Referring to FIG. 1, a toner shield 20 may be positioned on a developer roller 12 to reduce toner dusting as the developer roll rotates. The developer roll 12 rotation causes rotation against a doctor blade 28. As a result, toner dusting may occur on the doctor blade 28, as well as other surfaces.

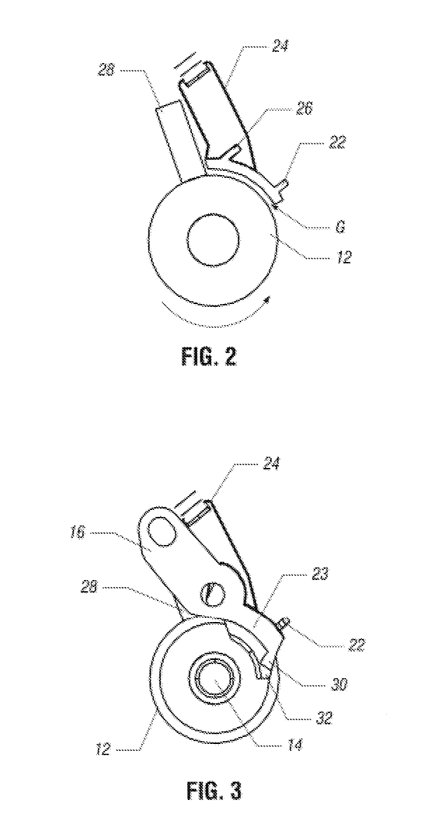

Referring to FIG. 2, the shield 20 conforms to or circumferentially follows the curvature of the roll 12 to reduce the tendency of toner particles to accumulate and to be blown about the printer environment. Most directly, the shield 20 shields the doctor blade 28 from toner accumulations.

In some embodiments of the present invention, the shield 20 may be secured to upstanding tabs on other printer components. Easy installation may be achieved by securing one arm 16 to a tab and then snapping the map connector 36 on the other arm 24 to another upstanding tab to quickly, releasably secure the shield 20 to the printer.

The shield 20 includes a pair of lengthwise extending ribs 22 and 26. These ribs may be useful in strengthening the lengthwise extent of the shield 20. Without the ribs, the shield strength may be too weak and it might bow into or away from the developer roll 12. The angles chosen for the ribs 22 and 26, in some embodiments, allow easy tooling for manufacturing the shields. The molding tool may be pulled away from the shield, parallel to the flanges, so that the ribs assist in the molding process. Geometry constraints may arise from the photoconductor drum location and the cartridge top shutter.

The arm 16 may have an extension 21 (FIG. 3) and a radially, inwardly directed extension 30. The extension 30 covers a printer contact 32 on the developer roll 12. The shield extension's geometry may create a space for the electrical contact to attach to the developer roll 12. If the contact 32 were uncovered, some of the developer roll's surface may cause increased toner spray. Thus, by covering the contact 32, toner spray can be reduced.

At the end of the developer roll, a gap G (FIG. 2) smaller than 1 millimeter may exist between the developer roll and the shield 20 in some embodiments. Another extension 23 covers the developer roll 12 end area proximate the gap G, above the developer shaft 14, and this extension 23 may contact the developer roll 12 bearing (not shown). This small extension 23 may block another airflow path between the developer roll 12 and the shield 20 via the gap G.

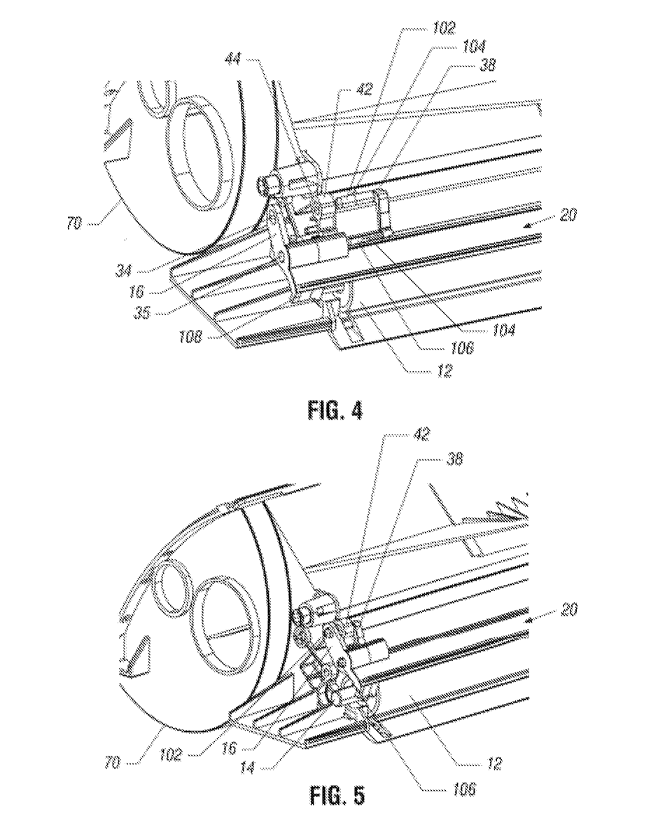

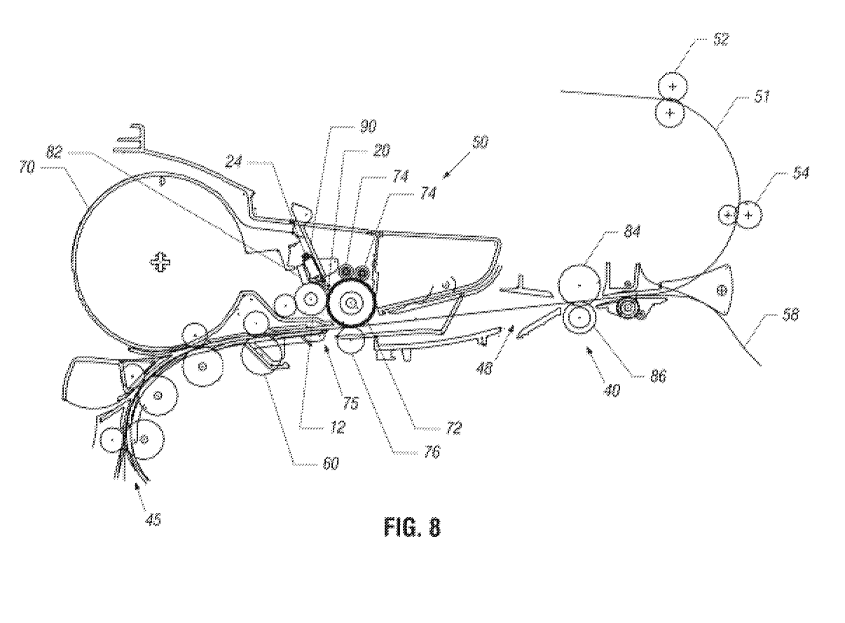

Referring to FIG. 4 and 4, in accordance with one embodiment, the arm 16 and its holes 34 and 35 may be used to secure the shield 20 to other printer components such as a printer housing or a developer tube 108. To this end, an anchor 42 may extend upwardly from the tube 108 of the printer 50 (FIG. 8). The anchor 42 may have enough holes 44. The parallel pins 102 and 106 of a U-shaped upstop 38 may pass through the through the holes 44 in the anchor and the through holes 34 and 35 in the arm 16. The upstop 38 is secured by spring catches 104 on each pin 102, 106. Thus, a snap connection may be established.

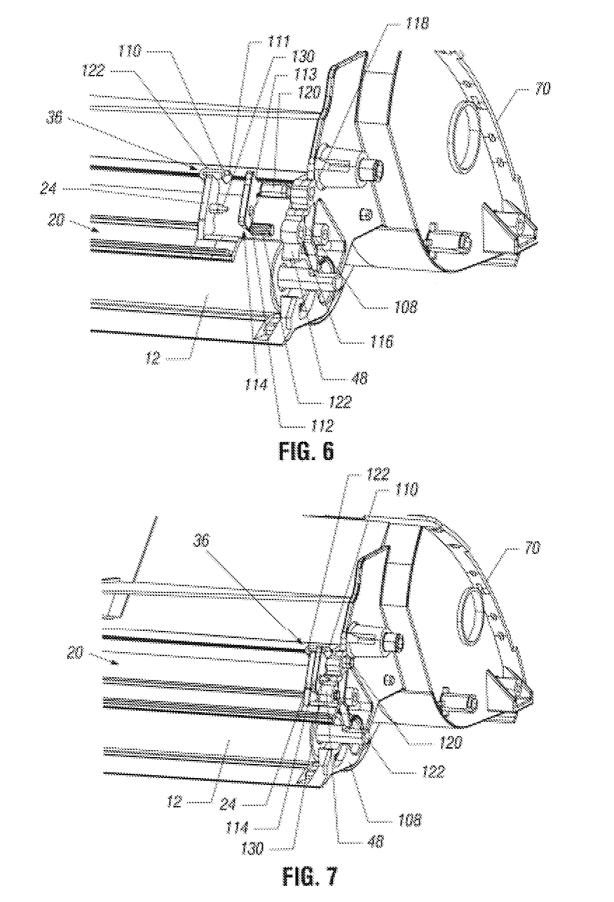

An anchor 48, shown in FIGS. 6 and 7, extending from the developer tube 108, may be engaged in a friction or press fit with the arm 24. In such case, a male/female securement may occur. The upstop 114 is U-shaped and includes a pair of extending, parallel pins 120 and 122. The pins 120, 122 engage the openings 116 and 118 in the anchor 48 in a press fit. The body of the U-shaped upstop 114 includes an opening 112 and an upper edge 113.

The arm 24 includes an outwardly directed tapered pin 130. The latch 36 includes a spring arm portion 122 punctuated in a downwardly extending catch 110. Thus, when the shield 20 is pressed into the upstop 114, the pin 130 engages and passes through the opening 112 in the upstop 114 at the same time the latch 36 latches on the upper edge 113 of the upstop 114. It does this because of the tapered leading edge 111 of the catch 110 which springs the leaf spring arm portion 122 upwardly so that the catch 110 then may spring back down and secure on the outside side of the upstop 114 after the catch 110 moves past the edge 113.

In this position, better shown in FIG. 7, the pins 120 and 122 engage the anchor 48 in a press fit connection. At the same time, the pin 130 extends through the upstop 114 and onto the anchor 48. The catch 110 is latched over the upper edge 113 of the upstop 114. Thus, the upstop 114 is latched onto the anchor 48 by the pin 130 and the pins 122 and 120, which sandwich the anchor 48. As a result, the shield 20 may be readily removed from and secured to the rest of the printer housing.

Referring now to FIG. 8, the major components of a laser printer are shown in diagrammatic view, in which the laser printer is generally designated by the reference numeral 50. A removable and replaceable electrophotographic (EP) process cartridge is provided, generally designated by the reference numeral 70. This process cartridge 70 includes a new toner supply, photoconductive (PC) drum 72, developer roll 12, and a doctor blade 82. The EP process cartridge can contain enough toner for up to 25,000 prints, although smaller sized process cartridge also are available that can only print up to 7,500 prints.

Laser printer 50 also includes a charge rollers 74 and a transfer roller 76. The preferred charge rollers 74 have an operating life time of as least 250,000 prints, and perhaps as many as 300,000 prints. In a preferred laser printer manufactured by Lexmark International Inc., the charge roller is replaced as part of a maintenance kit, which also includes a new fuser 40 and paper path rollers. The preferred laser printer will provide a message to the user when a “maintenance count” reaches 250,000 (representing 250,000 print) by displaying a message on the operator panel for the user to see that it is time to have a maintenance kit installed.

Major portions of the paper pathway 45 for the laser printer 50 are also illustrated in a FIG. 8 which allows paper to be supplied from a paper tray (not shown) or from a manually-fed paper input. As the paper (or other type of print media) approaches the print engine, the pathways merge at a final input roller set 60, and the paper pathway continues at 75 until the paper reaches the photoconductive drum 72 at the print engine stage.

References throughput this specification to “one embodiment” or “an embodiment” mean that a particular feature, structure, or characteristic described in connection with the embodiment is included in as least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
positioning a shield over a developer roll and adjacent to a doctor blade to reduce toner dusting.

2. The method of claim 1 including covering an electrical contact on the side of said roll with said shield.

3. The method of claim 1 including providing a gap between said shield from said roll.

4. The method of claim 3 including providing an arm to secure said shield over said developer roll and providing an extension on said shield to cover said gap.

5. The method of claim 1 including arranging said shield to extend completely across the length of said roll.

6. The method of claim 1 including removably securing said shield to said printer.

7. The method of claim 6 including securing said shield to said printer by a snap connection.

8. The method of claim 1 including positioning said shield adjacent to said doctor blade so that said roll rotates past said shield to said doctor blade.

9. The method of claim 8 including providing a strengthening rib on said shield.

10. The method of claim 1 including providing a pair of lengthwise strengthening ribs on said shield.

11. The method of claim 10 including angling said ribs away from the doctor blade.

12. A shield assembly comprising:
A toner spray shield to extend over and along the length of a developer roll; and
a pair of opposed arms to secure said shield to a printer in a position spaced from said developer roll.

13. The assembly of claim 12 wherein said shield includes an extension over the side of said developer roll.

14. The assembly of claim 12 wherein said arms to mount said shield adjacent a doctor blade and spaced over a developer roll.

15. The assembly of claim 14 wherein said shield is adapted to snap fit over said developer roll.

16. The assembly of claim 12 wherein said shield includes a pair of spaced ribs extending outwardly from said shield along the length of said shield.

17. The assembly of claim 16 wherein said ribs are spaced from one another in the direction of printer rotation.

18. The assembly of claim 17 wherein said ribs angle away from a doctor blade.

19. A printer comprising:
a housing;
a doctor blade on said housing;
a developer roll mounted on said housing for rotation past said doctor blade; and
a shield assembly over said developer roll.

20. The printer of claim 19 wherein said shield assembly includes an extension over the side of said developer roll.

21. The printer of claim 19 including a pair of arms to mount said shield assembly adjacent a doctor blade and spaced over the developer roll.

22. The printer of claim 21 wherein said shield assembly is adapted to extend along the length of said developer roll.

23. The printer of claim 22 wherein said shield assembly outwardly from said shield along the length of said shield.

24. The printer of claim 23 wherein said ribs are spaced from one another in the direction of printer rotation.

25. The printer of claim 24 wherein said ribs are adapted to an angle away from a doctor blade.

26. The printer of claim 19 wherein said shield assembly includes outwardly extending arms on opposed ends of said roll to secure said shield assembly to said housing.

27. The printer of claim 26 wherein one of said arms includes on opening for receiving a pin.

28. The printer of claim 26 wherein one of said arms includes a snap connector.

29. The printer of claim 28 including a U-shaped upstop having pins which engage openings on said housing.

30. A printer cartridge comprising:
a housing;
a doctor blade on said housing;
a developer roll mounted on said housing for rotation past said doctor blade; and
a shield assembly over said developer roll.

31. The printer cartridge of claim 30 including a pair of arms to mount said shield assembly adjacent a doctor blade and spaced over the developer roll.

32. The printer cartridge of claim 31 wherein said shield assembly is adapted to extend along the length of said developer roll.

33. The printer cartridge of claim 30 wherein said shield assembly includes outwardly extending arms on opposed ends of said roll to secure said shield assembly to said housing.

34. The printer cartridge of claim 33 wherein one of said arms includes a snap connector.
